(19) United States
(12) Patent Application Publication
(10) Pub. No.: US 2023/0041694 A1
(43) Pub. Date: Feb. 9, 2023

(54) STRUCTURE FOR THE TREATMENT OF POLLUTING LIQUIDS

(71) Applicant: NOVIDEAS S.R.L., Sanluri (IT)

(72) Inventors: Edoardo Sanna, Capoterra (IT); Ludovico Sanna, Capoterra (IT)

(21) Appl. No.: 17/759,094

(22) PCT Filed: Jan. 28, 2021
(86) PCT No.: PCT/IB2021/050650

§ 371 Date: Jul. 19, 2022

(30) Foreign Application Priority Data
Jan. 29, 2020 (IT) 102020000001711

(51) Int. Cl. C02F 3/20; B01F 23/231; B01F 23/232; B01F 33/503; B01F 23/237; B01F 35/71

(52) U.S. Cl. CPC C02F 3/201; B01F 23/231265; B01F 23/232311; B01F 33/503; B01F 23/237611; B01F 35/71805; C02F 2203/006; B01F 2101/305

(57) ABSTRACT

A structure adapted to be at least partially immersed in a liquid to be purified, in particular sewage,
the structure comprising:
   a hollow body provided with at least one inlet opening and at least one outlet opening for the liquid;
   first dispensing means adapted to dispense an oxygen-containing gas, for example air, arranged so as to generate a flow of fluid, in particular a mixture of sewage and said gas, towards said at least one outlet opening;
   second dispensing means adapted to dispense an oxygen-containing gas, for example air, arranged so as to generate a flow of fluid, in particular a mixture of sewage and said gas, outside the hollow body.

### CROSS-REFERENCE TO RELATED APPLICATIONS

This application claims priority to PCT International Application No. PCT/IB2021/050650 filed on Jan. 28, 2021, which application claims priority to Italian Patent Application No. 102020000001711 filed on Jan. 29, 2020, the entire disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention relates to the field of treating, in particular purifying, polluted liquids, in particular sewage or urban wastewater or liquids polluted by organic compounds.

In particular, the invention relates to a structure, or device, adapted to be arranged in a lagoon or in a tank, which allows the formation of granular sludge by the production of EPS (Extra-cellular Polymeric Substances).

### Background Art

Polluted liquids are frequently transferred into special purifying lagoons, where a series of processes is carried out for purifying the liquid.

Typically, purifying lagoons are divided into consecutive zones, or a series of lagoons is provided, in each of which a specific step of the purifying process is carried out.

For example, there are provided: an anaerobic zone, dedicated to the removal of solids by sedimentation; an optional zone, in which both aerobic processes on the surface and anaerobic processes at the bottom take place; an oxidation zone, in which oxidation processes take place; and a maturation zone, dedicated to the removal of the microbial load.

In particular, in order to favor the oxidation process of the organic fraction, the turbulence of the liquid is increased in the oxidation lagoons or zones. To this end, turbines arranged close to the surface or a network of gas dispensers secured to the bottom of the lagoon can be used.

Disadvantageously, the turbines have a low energy throughput and further require the presence of a great number of electromechanical devices.

Installing the network of gas dispensers is complex and, considering that the dispensers are secured to the bottom, the maintenance thereof is also difficult, for example when there are obstructions of the dispensers.

Furthermore, the oxidation processes, which take place in the oxidation lagoons, are typically slow and the yield is very low.

The need is thus felt to improve the oxidative processes of the organic fraction of a liquid to be purified, in particular in oxidation lagoons or zones, as well as in oxidation tanks.

### SUMMARY OF THE INVENTION

It is an object of the present invention to provide a structure or device which allows improving the treatment of a polluted liquid in a lagoon or tank, in particular an oxidation tank or lagoon.

In particular, it is an object of the present invention to provide a structure or device which allows improving the oxidation processes in an oxidation lagoon or tank.

The present invention achieves at least one of such objects, and other objects which will become apparent in the light of the present description, by means of a structure or device adapted to be at least partially immersed in a liquid to be purified, in particular sewage,

the structure comprising:
a hollow body provided with at least one inlet opening and at least one outlet opening for the liquid;
first dispensing means adapted to dispense an oxygen-containing gas, arranged so as to generate a flow of fluid, in particular a mixture of sewage and said gas, towards said at least one outlet opening;
second dispensing means adapted to dispense an oxygen-containing gas, arranged so as to generate a flow of fluid, in particular a mixture of sewage and said gas, outside the hollow body.

Advantageously, the structure can be used for purifying polluted liquids, in particular sewage or urban wastewater or slurry. The liquid can be contained in an oxidation tank or can be the liquid of an oxidation lagoon or an oxidation zone. Advantageously, the structure can also be used for interventions of reclaiming lagoons polluted by organic compounds.

Advantageously, the structure allows both an improvement in the exposure of the organic fraction to oxygen and an improvement in the liquid mixing.

In particular, the structure favors the formation of activated sludge, in particular granular sludge, by producing EPSs (Extra-cellular Polymeric Substances), and also prevents undesired accumulations of material at the bottom of the lagoon or tank, in particular of organic and inorganic compounds.

The EPSs significantly contribute to the process of degradation of the organic fraction of the polluted liquid. In particular, the EPSs contribute to the formation of granular activated sludge or aerobic granular sludge, in particular of the suspended-culture type.

For the production of EPS, it is important for the liquid to be adequately exposed to oxygen. Advantageously, since the liquid is temporarily confined inside the hollow body, the liquid is particularly exposed to the oxygen contained in the gas dispensed by the first dispensing means, resulting in an over-oxygenation of the organic fraction of the liquid.

In order to improve the production of EPS, the liquid can be subjected to shear stress and compression. This condition can be obtained by a section narrowing of the hollow body, as described below.

Advantageously, by dispensing oxygen-containing gas, the structure allows generating fluid motions and favoring exposure to oxygen of the organic fraction in the most convenient zones of the lagoon or tank as a function of the operational requirements. Indeed, the structure can be easily moved where required.

In particular, the structure is adapted to be at least partially immersed in the liquid of an oxidation lagoon or in the liquid contained in an oxidation tank.

In particular, the structure is adapted to be at least partially immersed so that said at least one inlet opening is closer to the bottom of the lagoon or tank, and said at least one outlet opening is further from the bottom.

Preferably, in this position, the first dispensing means, and preferably the second dispensing means as well, are configured to generate a flow of fluid which is, at least initially, ascending.

The presence of both the first dispensing means and the second dispensing means is advantageous in that the first dispensing means favor cell lysis and production of EPS, while the second dispensing means serve to obtain the mixing of the liquid outside the hollow body.

The mixing outside the hollow body is particularly important to prevent the stratification of the organic and inorganic compounds, which can result in an accumulation thereof at the bottom of the lagoon. Such an accumulation can result in a decrease in the useful volume of the lagoon or tank, where the useful volume is the volume in which the desired biological transformation processes of the organic fraction may occur. Such an accumulation can also result in the triggering of undesired fermentation phenomena.

Due to the second dispensing means, costly systems are not required to create turbulence in the lagoon or tank. Furthermore, a localized mixing can be obtained outside the hollow body. Advantageously, the structure can be moved to different zones of the lagoon or tank.

Preferably, the first dispensing means and the second dispensing means are constrained to the hollow body, preferably are integrally secured to the hollow body. Thereby, by moving the structure, both the second dispensing means and the structure itself can advantageously act as a function of the conditions of the liquid in the lagoon or contained in the tank.

Furthermore, maintenance of the dispensing means is particularly easy.

Advantageously, it is also possible to provide that the gas flow rate coming out of said first dispensing means and the gas flow rate coming out of said second dispensing means can be adjusted, preferably independently of each other.

Thereby, it is possible to create optimal conditions, as a function of the actual operating needs, for treating the liquid, in particular by adjusting the production of EPS, controlling the flow rate of the first dispensing means, and adjusting the mixing of the liquid outside the hollow body, controlling the flow rate of the second dispensing means.

To this end, there are provided adjusting means adapted to adjust said gas flow rate which can come out of said first dispensing means, and said gas flow rate which can come out of said second dispensing means, preferably independently of each other.

Preferably, the oxygen-containing gas is air.

By way of an example, the oxygen-containing gas can also be a nitrogen and oxygen mixture in different proportions with respect to those which are characteristic of air, or air with the addition of further oxygen, or air with the addition of further ozone.

Preferably, the first dispensing means and the second dispensing means are adapted to dispense the same gas, i.e. the same type of gas, which is preferably air.

Generally, the use of one or more structures according to the invention favors the formation of granular sludge and the movement of the mass of water. Therefore, it is possible to obtain: a reduction in energy consumption; a reduction in the production of excess sludge; improved sludge sedimentability; and improved resistance to peaks of an organic or hydraulic nature.

Furthermore, the structure of the invention can be easily used in lagoons or existing activated sludge systems or in lagoons polluted by organic compounds, without requiring structural interventions and without needing to empty the tank.

Optionally, in all the embodiments of the invention, in addition to, or as an alternative to, the second gas dispensing means, there are provided means adapted to generate a flow of fluid, in particular of the electromechanical type, such as one or more turbines or one or more jet flows, for example. Nonetheless, using the second gas dispensing means is preferable, in particular because they allow the costs to be limited and can be installed more easily and the maintenance thereof is also easier.

Further features and advantages of the invention will become more apparent in light of the detailed description of non-exclusive, exemplary embodiments.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 diagrammatically shows a section of an example of structure according to the invention;

FIG. 2 diagrammatically shows a top view of the structure in FIG. 1;

FIG. 2A diagrammatically shows an enlarged detail of a component of the structure according to the invention;

FIG. 3 diagrammatically shows a section of another example of structure according to the invention;

FIG. 4 diagrammatically shows a top view of the structure in FIG. 3;

FIG. 5 diagrammatically shows a perspective view of the structure in FIG. 3;

FIG. 6 diagrammatically shows a section of another example of structure according to the invention;

FIG. 7 diagrammatically shows a top view of the structure in FIG. 6;

FIG. 8 shows a particular example of some components of a structure according to the invention;

FIG. 8A diagrammatically shows an enlarged detail of a component of the structure according to the invention;

FIG. 9 diagrammatically shows the operation of a structure according to the invention.

The same elements, or functionally equivalent elements, have the same reference numeral.

### DESCRIPTION OF EXEMPLARY EMBODIMENTS OF THE INVENTION

With reference to the Figures, exemplary embodiments of a structure 101, 102, 103, 104, or device, according to the invention are described.

The structure 101, 102, 103, 104 is adapted to be at least partially immersed in a liquid to be purified, in particular sewage or wastewater.

In particular, the structure 101, 102, 103, 104 is adapted to be at least partially immersed in the liquid of a lagoon (shown partially and diagrammatically, and indicated by reference sign “L”) or in the liquid contained in a purification tank.

In all embodiments, the structure 101, 102, 103, 104 comprises:
a hollow body 1 provided with at least one inlet opening 11 and at least one outlet opening 12 for the liquid;
first dispensing means 21 adapted to dispense an oxygen-containing gas, for example air, arranged so as to generate a flow of fluid, in particular a mixture of sewage and said gas, towards said at least one outlet opening 12, in particular a flow of fluid at least partially crossing the hollow body 1 and coming out of said at least one outlet opening 12;
and second dispensing means 22 adapted to dispense an oxygen-containing gas, for example air, arranged so as to generate a flow of fluid, in particular a mixture of sewage and said gas, outside the hollow body 1, preferably only outside the hollow body 1.

Preferably, the first dispensing means 21 and the second dispensing means 22 are constrained to said hollow body 1. In particular, the first dispensing means 21 and the second dispensing means 22 are preferably integrally secured to the hollow body 1.

The first dispensing means 21 preferably are distinct from the second dispensing means 22.

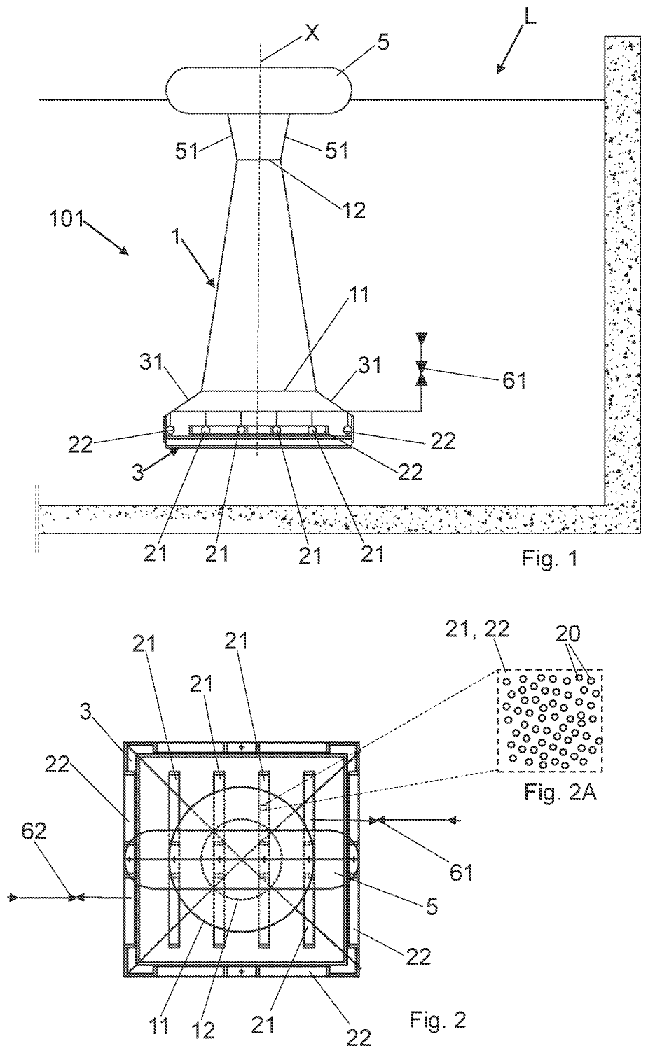

Preferably, the first dispensing means 21 comprise or consist of one or more gas diffusers, each provided with a plurality of openings 20 (FIGS. 2A, 8A) for example, pores or holes, from which the oxygen-containing gas, for example air, can come out. In particular, the diffusers can be porous or micro-perforated.

Preferably, the second dispensing means 22 also comprise one or more gas diffusers, each provided with a plurality of openings 20, for example pores or holes, from which the oxygen-containing gas can come out, for example, air. In particular, the diffusers can be porous or micro-perforated.

Preferably, but not exclusively, the second dispensing means 22 comprise at least two diffusers 20, which are preferably arranged opposite to each other, in particular with respect to the axis X about which the hollow body 1 preferably extends.

The diffusers can have various shapes or conformations.

The diffusers can consist, for example, of one or more tubes, the outer side surface of which is provided with a plurality of pores or holes, preferably having micrometric dimensions. Alternatively, the diffusers can be disk-shaped or flat diffusers, and even in this case, they are provided with a plurality of pores or holes, preferably of micrometric dimensions. As a function of the dimensions of the openings, the diffusers can generate gas bubbles, for example of air, which are large, medium, or fine.

By way of an example, FIG. 2A diagrammatically shows a surface portion of the dispensing means 21 or equivalently of the dispensing means 22, provided with a plurality of openings 20, which are holes or pores, for example.

Preferably, the openings 20 of the first dispensing means 21 and the openings 20 of the second dispensing means 22 are present at least or only on one upper face or upper portion of the respective dispensing means 21, 22, i.e. the face or portion opposite to the face or portion adapted to face the bottom of the lagoon or tank.

Therefore, the second dispensing means 22 are preferably adapted to generate or dispense said flow of gas, for example air, outside the hollow body 1 along a direction, which is, at least initially, ascending (with reference to the figures), i.e. going in a distal direction with respect to the bottom of the lagoon or tank.

Each of the aforesaid openings 20 of the diffusers can have, for example, a diameter of from 30 μm (micrometers) to 5 mm (millimeters).

As already said, the openings 20 can be holes, in particular micro-holes, or pores, obtained by way of an example by cutting or die-cutting an elastic material from which the diffusion surface is obtained.

The first dispensing means 21 and the second dispensing means 22 are adapted to be connected to means for generating a flow of oxygen-containing gas, preferably air, for example by means of one or more ducts.

The means for generating a flow of gas can comprise or consist of, for example, one or more compressors.

The first dispensing means 21 and the second dispensing means 22 can be connected, for example, preferably by means of at least one respective duct, to the same compressor adapted to generate a flow of gas, for example air.

Alternatively, the first dispensing means 21 and the second dispensing means 22 can be connected to a respective compressor, by means of at least one respective duct, each compressor being adapted to generate a respective flow of gas, for example air.

In any case, preferably, the flow rate of the first dispensing means 21 and the flow rate of the second dispensing means 22 can be adjusted by the adjustment means 61, 62.

Preferably, the structure 101, 102, 103, 104 is configured so that the gas flow rate, which can come out of said first dispensing means 21, and the gas flow rate, which can come out of said second dispensing means 22, can be adjusted independently of each other.

For example, adjustment means 61, 62 are preferably provided, adapted to adjust said gas flow rate, which may come out of said first dispensing means 21, and said gas flow rate, which may come out of said second dispensing means 22 independently of each other.

In particular, first adjustment means 61, connected to the first dispensing means 21, and second adjustment means 62, connected to the second dispensing means 22, are preferably provided, the first adjustment means 61 being distinct from the second adjustment means 62.

Said adjustment means 61, 62 can comprise or consist of, for example, one or more valves, in particular one or more respective valves. In other words, the adjustment means 61 preferably comprise or consist of one or more valves; and the adjustment means 62 comprise or consist of one or more valves.

The valves can be, for example, of the manual operation- or automatic operation-type.

In particular, said one or more valves are adjustment valves.

The adjustment means 61, 62 can be integrated, for example, in the dispensing means 21, 22 or can be arranged along one or more ducts, which are adapted to connect, for example which connect, the dispensing means 21, 22 to the means for generating a flow of gas, for example to one or more compressors.

The adjustment means 61, 62 can be controlled, for example, from the ground or from the tank edge.

In particular, the second dispensing means 22 are arranged outside the hollow body 1. Preferably, the second dispensing means 22, in particular the openings 20 thereof, are radially outside the hollow body 1. Preferably, the second dispensing means 22, in particular the openings 20 thereof, are outside the orthogonal projection on a plane perpendicular to the axis X, and containing the axis X, of the edge of the hollow body 1 delimiting the inlet opening 11.

Although it is preferable that the second dispensing means 22 are beneath said at least one inlet opening 11, in order to obtain a better mixture, the second dispensing means 22 can also be arranged at a different height, for example at a height, along the axis X, equal to or greater than the at least one inlet opening 11.

The first dispensing means 21 can be arranged inside the hollow body 1 and/or outside the hollow body 1, in particular at said at least one inlet opening 11. In any case, preferably, the first dispensing means 21, in particular the openings 20 thereof, are radially inside the hollow body 1. Preferably, the first dispensing means 21, in particular the openings thereof, are inside the orthogonal projection on a plane perpendicular to the axis X, and containing the axis X, of the edge of the hollow body 1 delimiting the inlet opening 11.

For example, the first dispensing means 21 can be only inside or only outside the hollow body 1, or some first dispensing means 21 can be arranged inside and other first dispensing means 21 can be arranged outside the hollow body 1.

In particular, when the first dispensing means 21 are inside the hollow body 1, the latter surrounds the first dispensing means 21.

Preferably, the first dispensing means 21 and the second dispensing means 22 are proximal to the at least one inlet opening 11 and distal to the at least one outlet opening 12.

Optionally, the distance between the first dispensing means 21 and said at least one outlet opening 12 is less than the distance between said second dispensing means 22 and said at least one outlet opening 12. In other words, the first dispensing means 21 and the second dispensing means 22 are at different heights with respect to the at least one outlet opening 12.

Alternatively, the first dispensing means 21 and the second dispensing means 22 are substantially at the same height, i.e. they are substantially coplanar.

Preferably, the second dispensing means 22 are arranged about the axis X.

Preferably, the structure 101, 102, 103, 104 comprises a support 3 constrained to said hollow body 1, in particular close to said at least inlet opening 11. Preferably, the support 3 faces the at least one inlet opening 11 and is preferably spaced apart therefrom. The support 3 acts as a ballast, which is useful for maintaining the desired arrangement, in particular, the vertical arrangement.

The support 3 can be constrained to the hollow body 1, for example, by means of connection arms 31 or tie-rods.

Preferably, the first dispensing means 21 and/or the second dispensing means 22 are constrained to said support 3. For example, the first dispensing means 21 and/or the second dispensing means 22 can be secured to one side or face of the support 3 facing the at least one inlet opening 11.

Alternatively, the first dispensing means 21 and/or the second dispensing means 22 are constrained, in particular directly constrained, to the hollow body 1 by fixing means.

As anticipated, the hollow body 1, in particular the side wall thereof, extends about the aforesaid axis X, which is preferably the longitudinal axis of the hollow body 1.

The side wall of the hollow body 1 delimits said at least one inlet opening 11 and said at least one outlet opening 12.

Preferably, the hollow body 1 has a substantially truncated-cone shape, i.e. the side wall of the hollow body 1 has a substantially truncated-cone shape. Nonetheless, the hollow body 1 can also have other shapes, for example a bell or truncated-pyramid shape.

Preferably, the hollow body 1 consists only of said side wall.

The hollow body 1 can be made, for example, of metal or plastic or fiberglass. Preferably, the hollow body 1 is made of steel, or aluminum or aluminum alloy.

Preferably, the inlet opening 11 and the outlet opening 12 are delimited by a respective end or end portion of the side wall of the hollow body 1, the ends being opposite to each other.

Preferably, at least the inlet opening 11 extends about the axis X.

Preferably, the inlet opening 11 and the outlet opening 12 are mutually coaxial, preferably are coaxial to the axis X.

The inlet opening 11 and the outlet opening 12 can also be transverse to each other. For example, the inlet opening 11 can extend about the axis X, and the outlet opening 12 (or the outlet openings) can extend about an axis, which is transverse, for example orthogonal, to the axis X.

Preferably, the hollow body 1 is provided with a section narrowing at or close to said at least one outlet opening 12.

Preferably, the area or section of said at least one outlet opening 12 is smaller than the area or section of said at least one inlet opening 11.

Preferably, the area of said at least one outlet opening 12 is at least 3 times smaller or at least 5 times smaller than the area of said at least one inlet opening 11. Preferably, the area of said at least one outlet opening 12 is from 3 to 100 times or from 5 to 100 times smaller than the area of said at least one inlet opening 11.

Therefore, at the at least one outlet opening 12, there is substantially a section narrowing of the hollow body 1.

These specific dimensional ratios are selected so that, in particular, at the at least one outlet opening 12, the liquid is subjected to shear stress and/or compression.

In fact, the liquid is forced to pass through the outlet opening 12 as it is pushed by the flow of gas dispensed by the first dispensing means 21. Furthermore, since the liquid is temporarily confined inside the hollow body 1, the liquid is particularly exposed to the oxygen contained in the dispensed gas, resulting in an over-oxygenation of the organic fraction of the liquid.

Optionally, the area of the at least one inlet opening 11 and the area of the at least one outlet opening 12 can be adjusted, for example by means of a respective movable element which can partially obstruct the respective opening, while remaining in the aforesaid dimensional parameters.

Preferably, the hollow body 1 is provided with only one inlet opening 11 and/or with only one outlet opening 12.

Alternatively, the hollow body 1 can be provided with a plurality of inlet openings 11 and/or with a plurality of outlet openings 12.

Preferably, in this case, the sum of the areas of the outlet openings 12 is at least 3 times smaller, for example from 3 to 100 times, or at least 5 times smaller, for example from 5 to 100 times, smaller than the sum of the areas of the inlet openings 11.

Optionally, the area of said at least one outlet opening 12, or the sum of the areas of the outlet openings 12, is from 9 to 20000 cm², or from 9 to 5000 cm².

Preferably, the distance between the inlet opening 11 and the outlet opening 12 corresponds to the height, in particular to the maximum height, of the hollow body 1 along the axis X.

Preferably, the structure 101, 102, 103, 104 is configured to float in the liquid in which it is immersed.

For example, the structure 101, 102, 103, 104 can comprise at least one floating body 5, i.e. adapted to float. The floating body 5 is constrained to the hollow body 1. For example, the floating body 5 can be directly constrained to the hollow body 1 by means of connection arms 51 or tie-rods (FIG. 1), or can be constrained to a deflector 4 (described below) which is constrained, in turn, to the hollow body 1.

Preferably, the structure 101, 102, 103, 104 is configured so that, when immersed in the liquid, said at least one inlet opening 11 is at a distance from the bottom of the lagoon or tank which is smaller than the distance between said at least one outlet opening 12 and the bottom of the lagoon or tank.

Preferably, the floating body 5 is in an upper zone of the structure 101, 102, 103, 104, i.e., in a zone adapted to be distal from the bottom of the lagoon or tank.

Preferably, the floating body 5 is at, i.e., defines, the top of the structure 101, 102, 103, 104.

Preferably, the structure 101, 102, 103, 104 is configured so that, when immersed in the liquid, said at least one outlet opening 12 is adapted to remain beneath the surface of the liquid.

In addition to or as an alternative to the floating body 5, the structure 101, 102, 103, 104 can be constrained to the bottom of the lagoon or tank, or to the ground surrounding the lagoon or to the edge of the tank, or can be suspended to an overhead structure, for example a boardwalk. The structure 101, 102, 103, 104 can also rest at the bottom of the tank or the lagoon.

Preferably, the structure 101, 102, 103, 104 comprises a deflector 4 facing said at least one outlet opening 12 and spaced apart from said at least one outlet opening 12, adapted to direct the flow of liquid which may come out of said at least one outlet opening 12 transversely, preferably radially, with respect thereto.

The face of the deflector 4 facing the outlet opening 12 can be, for example, concave or convex or flat.

The deflector 4 can be constrained to the hollow body 1, for example by means of connection arms 41 or tie-rods.

With reference to FIGS. 1 and 2, an example of structure, indicated by numeral reference 101, comprises a truncated-cone-shaped hollow body 1. The structure 101 comprises the floating body 5 and the support 3. The floating body 5 is constrained to the hollow body 1 by means of the arms 51. The face of the floating body 5 facing the outlet opening 12 also acts as a deflector.

Both the first dispensing means 21 and the second dispensing means 22 are outside the hollow body 1, and in particular are secured to the support 3, more particularly to the face of the support 3 facing the inlet opening 11.

By way of a non-limiting example, the first dispensing means 21 comprise tubes, for example four tubes, preferably arranged parallel to one another. Each tube is provided with a plurality of openings 20. In particular, the openings 20 of the first dispensing means 21 face the inlet opening 11. The openings 20 of the first dispensing means 21 are arranged so that when the gas comes out thereof, a flow is generated, which passes first through the inlet opening 11 and then towards the outlet opening 12.

In particular, the first dispensing means 21, in particular the openings 20 thereof, are inside the orthogonal projection on a plane perpendicular to the axis X, and containing the axis X, of the edge of the hollow body 1 delimiting the inlet opening 11.

In the example shown, the second dispensing means 22 comprise tubes, for example four tubes, arranged parallel to a respective side of a square which is, in particular, around the four tubes of the first dispensing means 21.

Each tube of the second dispensing means 22 is provided with a plurality of openings 20. In particular, the second dispensing means 22, in particular the openings 20 thereof, are outside the orthogonal projection on a plane perpendicular to the axis X, and containing the axis X, of the edge of the hollow body 1 delimiting the inlet opening 11.

In particular, the openings 20 are obtained in the side wall of the respective tube, preferably at least or only in the upper part of the side wall of the tube.

When gas comes out of the openings 20 of the second dispensing means 22, a flow is generated, which goes, at least initially, from the bottom upwards (with reference to FIG. 1).

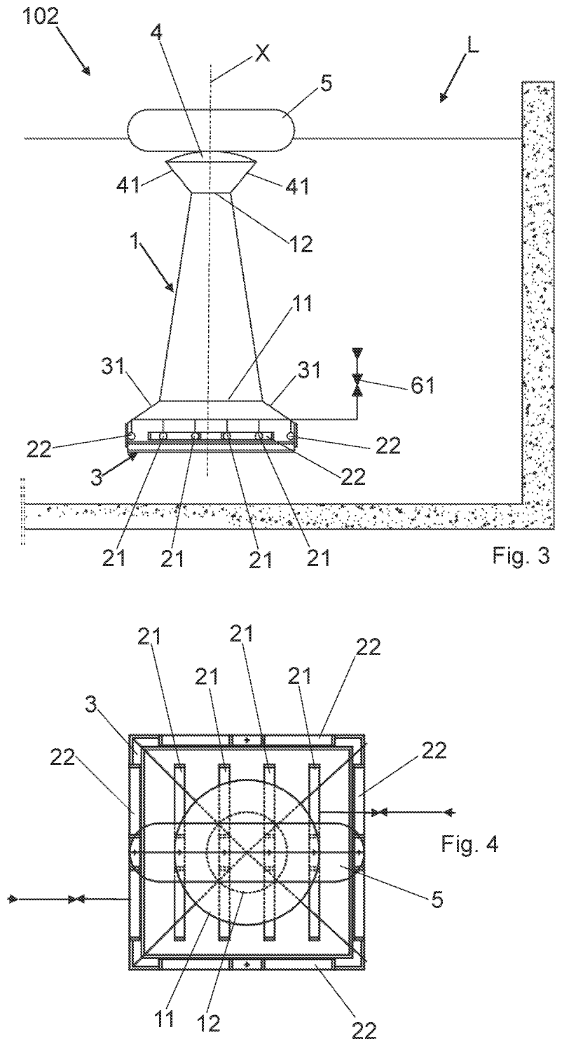

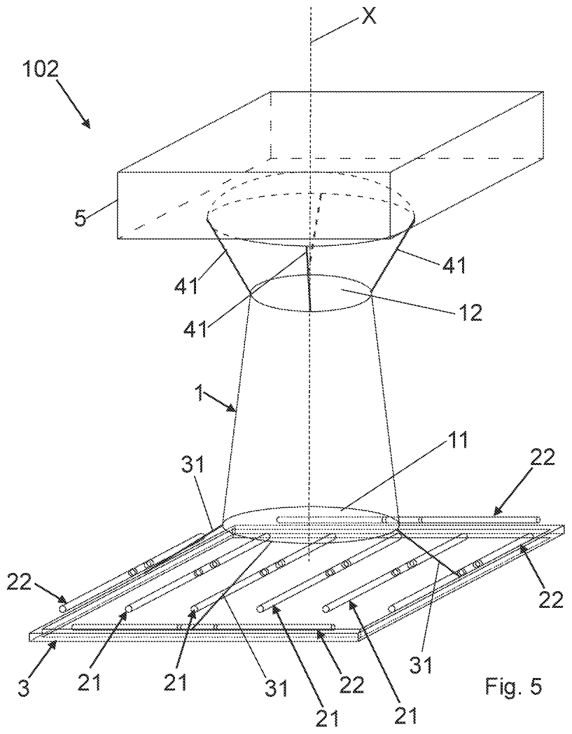

FIGS. 3, 4, and 5 show another example of a structure, indicated by reference numeral 102. The structure 102 differs from the structure 101 only in that it comprises the deflector 4. The deflector 4 is constrained to the hollow body 1 by means of the arms 41. In the example shown, the face of the deflector 4 facing the outlet opening 12 is concave, in particular concave towards the outlet opening 12. The floating body 5 is constrained to the deflector 4 and/or directly to the hollow body 1.

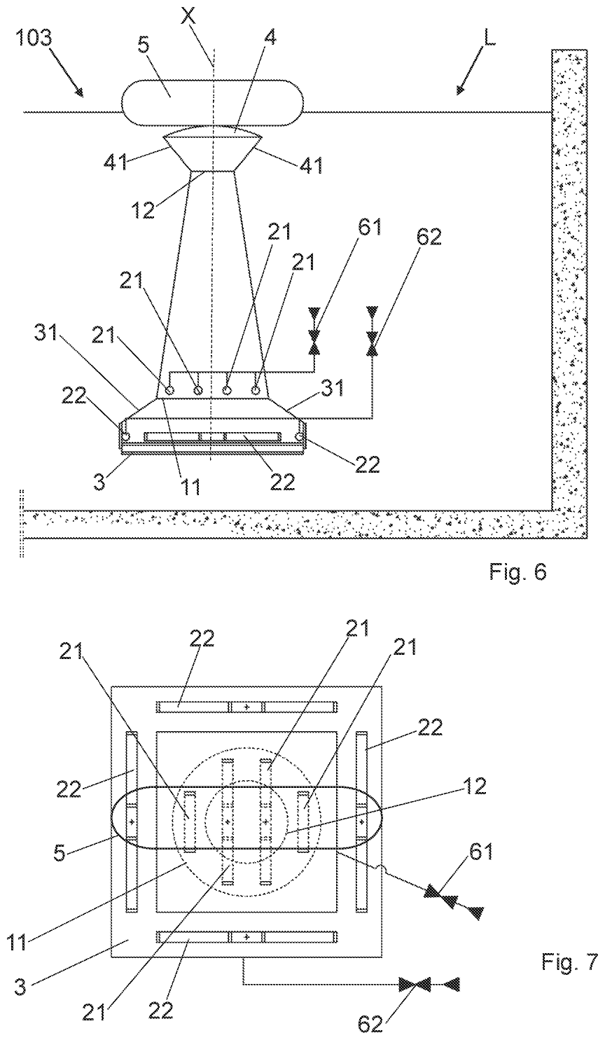

FIGS. 6 and 7 show another example of a structure, indicated by reference numeral 103. The structure 103 differs from the structure 102 only in that the first dispensing means 21 are inside the hollow body 1, and the second dispensing means 22 are outside the hollow body 1.

In particular, the first dispensing means 21 are surrounded by the end portion of the hollow body 1 which delimits the inlet opening 11. In other words, the first dispensing means 21 are close to the inlet opening 11 and, with reference to FIG. 6, above the inlet opening 11.

By way of example, the first dispensing means 21 comprise tubes, for example four tubes, preferably arranged parallel to one another, each provided with a plurality of openings 20 obtained in the side surface of the tube, in particular in the upper portion of the tube.

The second dispensing means 22 comprise four tubes arranged parallel to a respective side of a square.

Each tube of the second dispensing means 22 is provided with a plurality of openings 20 obtained in the side surface of the tube, in particular in the upper portion of the tube. In particular, the second dispensing means 22, in particular the openings 20 thereof, are outside the orthogonal projection on a plane perpendicular to the axis X, and containing the axis X, of the edge of the hollow body 1 delimiting the inlet opening 11.

When the gas comes out of the openings 20, a flow is generated, which, at least initially, goes from the bottom upwards (with reference to FIG. 6).

FIG. 8 shows another example of dispensing means 21, 22, which is applicable to all the embodiments of the invention.

The first dispensing means 21 comprise a plurality of disk-shaped diffusers, for example four disk-shaped diffusers, arranged inside the hollow body 1 and constrained thereto or arranged outside the hollow body 1, for example secured to the support 3, in particular at the inlet opening 11.

The second dispensing means 22 comprise a plurality of disk-shaped diffusers arranged, for example, according to a circular pattern, secured to the support 3 or to the hollow body 1.

The diffusers are provided with one or more respective openings 20, for example holes or pores.

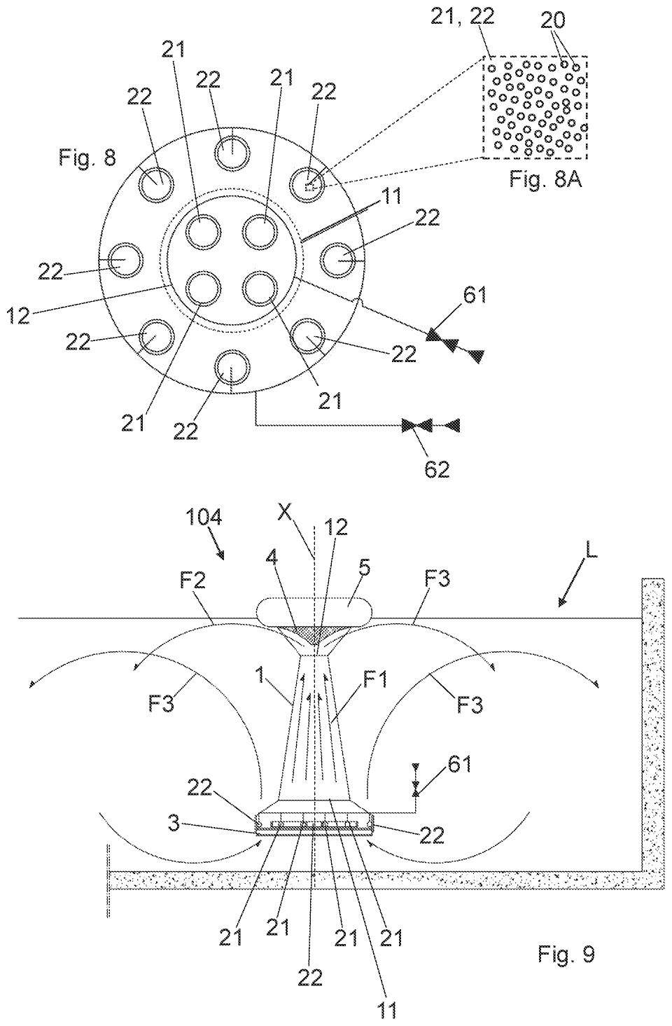

FIG. 9 diagrammatically shows the operation of a structure 101,102,103,104 according to the invention.

In particular, when the gas, for example air, comes out of the first dispensing means 21, a flow of fluid is generated (arrows F1), which crosses the hollow body 1 going towards the outlet opening 12. With reference to FIG. 9, the flow of fluid is ascending, i.e., is directed towards the surface of the liquid. In particular, the fluid inside the hollow body 1 is a mixture of liquid and oxygen-containing gas, more particularly sewage and oxygen-containing gas. In particular, when the fluid crosses the outlet opening 12, it is subjected to compression and/or shear stress which, together with the exposure to the oxygen contained in the gas coming out of the first dispensing means 21, significantly favors the production of EPS. The fluid then comes out of the outlet opening 12 (arrows F2), for example radially thereto as the deflector 4 is present (which is optional, as already explained). By way of a non-limiting example, the deflector 4 of the structure 104 optionally comprises two or more concave surfaces, this feature being the only difference with respect to the structure 102.

The arrows F3 diagrammatically show the flow of fluid generated by the gas coming out of the second dispensing means 22. In particular, even in this case, the fluid is a mixture of liquid and gas, more particularly sewage and gas. Preferably, the second dispensing means 22 are configured so that the flow of fluid generated is at least initially ascending, for example at least initially substantially parallel to the axis X.

Advantageously, a structure 101, 102, 103, 104 can be moved into the lagoon or tank as a function of the needs, for example, as a function of the conditions of the liquid.

1. A structure adapted to be at least partially immersed in a liquid to be purified, in particular sewage,
the structure comprising
a hollow body provided with at least one inlet opening and at least one outlet opening for the liquid;
first dispensing means adapted to dispense an oxygen-containing gas, arranged so as to generate a flow of fluid, in particular of a mixture of sewage and said gas, towards said at least one outlet opening;
second dispensing means adapted to dispense an oxygen-containing gas, arranged so as to generate a flow of fluid, in particular of a mixture of sewage and said gas, outside the hollow body;
wherein the gas flow rate which can come out of said first dispensing means and the gas flow rate which can come out of said second dispensing means can be adjusted independently of each other.

2. The structure according to claim 1, comprising adjustment means adapted to adjust said gas flow rate which can come out of said first dispensing means and said gas flow rate which can come out of said second dispensing means independently of each other.

3. The structure according to claim 2, wherein first adjustment means of said adjustment means, connected to the first dispensing means, and second adjustment means of said adjustment means, connected to the second dispensing means are provided; the first adjustment means being distinct from the second adjustment means.

4. The structure according to claim 2, wherein said adjustment means comprise or consist of one or more valves, in particular one or more respective valves.

5. The structure according to claim 1, wherein said first dispensing means and said second dispensing means are constrained to said hollow body.

6. The structure according to claim 1, wherein said first dispensing means are arranged radially further inward with respect to the edge of the hollow body which delimits said at least one inlet opening, and/or wherein said second dispensing means are arranged radially further outward with respect to the edge of the hollow body which delimits said at least one inlet opening.

7. The structure according to claim 1, wherein said first dispensing means are arranged inside the hollow body and/or wherein said first dispensing means are arranged outside the hollow body, in particular at said at least one inlet opening.

8. The structure according to claim 1, wherein said second dispensing means are arranged outside the hollow body, preferably radially outside with respect to the hollow body.

9. The structure according to claim 1, wherein said first dispensing means and said second dispensing means each comprise at least one diffuser provided with a plurality of openings, in particular pores or holes.

10. The structure according to claim 9, wherein said openings of the first dispensing means are present at least or only on one upper portion of the first dispensing means; and wherein said openings of the second dispensing means are present at least or only on an upper portion of the second dispensing means; in particular, wherein each upper portion is opposite to the portion adapted to face the bottom of a lagoon or tank containing said liquid to be purified.

11. The structure according to claim 1, comprising a support constrained to said hollow body, in particular close to said inlet opening; preferably wherein said support faces said at least one inlet opening and is preferably spaced apart from said at least one inlet opening.

12. The structure according to claim 11, wherein said first dispensing means and/or said second dispensing means are constrained to said support.

13. The structure according to claim 1, wherein the distance between said first dispensing means and said at least one outlet opening is less than or equal to the distance between said second dispensing means and said at least one outlet opening.

14. The structure according to claim 1, wherein said hollow body is provided with a section narrowing at or close to said at least one outlet opening.

15. The structure according to claim 1, wherein the area of said at least one outlet opening is at least 3 times or at least 5 times smaller than the area of said at least one inlet opening; preferably wherein the area of said at least one outlet opening is from 3 to 100 times or from 5 to 100 times smaller than the area of said at least one inlet opening.

16. The structure according to claim 1, comprising a deflector facing said at least one outlet opening and spaced apart from said at least one outlet opening, adapted to direct the flow of liquid which may come out from said at least one outlet opening transversely, preferably radially, with respect thereto.

17. The structure according to claim 1, comprising at least one floating body; preferably wherein the structure is configured so that, when it is immersed in the liquid, said at least one outlet opening is adapted to remain below the surface of the liquid.
